(19) United States
(12) Patent Application Publication
(10) Pub. No.: US 2007/0133232 A1
(43) Pub. Date: Jun. 14, 2007

(54) Technique to improve dynamic response of two-stage converters

(76) Inventor: James Sigamani, Quezon City (PH)

Correspondence Address: HARNESS, DICKEY & PIERCE, P.L.C., P.O. BOX 828, BLOOMFIELD HILLS, MI, 48303, US

(21) Appl. No.: 11/297,815

(22) Filed: Dec. 8, 2005

(51) Int. Cl. H02M 3/335

(52) U.S. Cl. 363/16

(57) ABSTRACT

A two-stage converter including a buck converter and a DC-DC converter that receives power from the buck converter. The DC-DC converter generates an output voltage of the two-stage converter. A buck control circuit generates a control signal for the buck converter. The control signal is based on a first signal representing the output voltage, a second signal representing load applied to the buck converter, and a compensation signal. A characteristic of the compensation signal varies based on the output voltage.

### FIELD

The present disclosure relates to power converter feedback circuits.

### BACKGROUND

The statements in this section merely provide background information related to the present disclosure and may not constitute prior art.

Two-stage converters have become attractive for high input voltage and low output voltage/high output current applications. The converters typically include a buck converter in the first stage. A second stage typically includes a DC-DC converter with isolation and operates at a fixed duty cycle around 50%. The second stage converter is typically one of a push-pull, half-bridge, forward, and full-bridge converter design.

Two-stage converters have several desirable characteristics. For example, synchronous rectification in the second stage can be optimized to use lower voltage rated MOSFETs since the transformer secondary voltage is minimized. Another characteristic is that the transformer primary voltage in the second stage is reduced and regulated by the first stage buck converter. This allows the efficiency of the second stage to be increased over single-stage design by using lower Rds(on) MOSFETs for the primary side switches.

Two-stage converters also have some disadvantages. For example, two-stage converters generally use only one control loop to regulate the output voltage. Since both the first stage and the second stage include LC filters, the control transfer function becomes 4^{th} order and control system design is challenging. Conventional compensations can be used to stabilize the two-stage converter but the dynamic response becomes poor. Also, when the two-stage converter operates with a high voltage input, such as 400V, the use of synchronous rectification in the first stage becomes impractical. Without synchronous rectification the buck converter behavior changes at light load. This further complicates the control system design.

Referring now to FIG. 1, a first type of prior art two-stage converter 100 is shown. A first stage 102 includes a buck converter that feeds a DC-DC converter second stage 104. First stage 102 includes a DC supply 106. In some embodiments, DC supply 106 provides between 300V and 400V. A positive terminal of DC supply 106 connects to a drain of a FET Q1 and one end of a capacitor C1. A negative terminal of DC supply 106 connects to a ground 108 and one end of a load sensing resistor R_{S}. A first inductor L1 connects between a source of FET Q1 and the other end of capacitor C1. A drain of a FET Q2 connects to a source of FET Q1. A source of FET Q2 connects to the other end of load sensing resistor R_{S}.

A buck control circuit 110 provides a first gate drive signal 112 to a gate of FET Q1 and a second gate drive signal 114 to a gate of FET Q2. Buck control circuit 110 generates first and second gate drive signals 112, 114 based on a load feedback signal 116 that is generated across load sensing resistor R_{S}. An output voltage of first stage 102 is generated across capacitor C1.

Second stage 104 is a full bridge DC-DC converter. A source of a FET Q3 connects to a drain of a FET Q5 and to a first terminal 120 of a transformer T1. A source of FET Q4 connects to a drain of FET Q6 and a second terminal 122 of transformer T1. A source of a FET Q4 connects to a drain of a FET Q6 and to a second terminal of transformer T1. Second stage 104 receives power from the output of first stage 102. The input voltage positive node, which appears at the top of capacitor C1, connects to drains of FET Q3 and FET Q4. The input voltage negative node, which appears at the bottom of capacitor C1, connects to sources of FET Q5 and FET Q6. A full bridge open loop controller 122 generates gate signals that are applied to respective gates of FETs Q3-Q6.

Transformer T1 includes a center-tapped secondary winding. The secondary winding includes a first terminal 130, a second terminal 132 and a center tap 134. A rectifier D1 has an anode connected to first terminal 130 and a cathode connected to a first end of a second inductor L2. A rectifier D2 has an anode connected to second terminal 132 and a cathode connected to the cathode of rectifier D1 and the first end of second inductor L2. The other end of inductor L2 connects to one end of a capacitor C2. The other end of capacitor C2 connects to center tap 134. The output voltage of two-stage converter 100 is generated across capacitor C2.

Buck control circuit 110 receives a feedback signal 140 that is based on the output voltage across capacitor C2. The feedback signal arrives at buck control circuit 110 through a feedback path that includes a compensation circuit 150 and an opto-isolator 152. The output voltage across capacitor C2 is applied to a first end of a capacitor C3 and one end of a resistor R1. The other end of capacitor C3 connects to a first end of a resistor R2. The second ends of resistors R1 and R2 are connected together and also connected to one end of a resistor R3 and an inverting input 154 of an operational amplifier 156. The other end of resistor R3 connects to ground 108. A non-inverting input of operational amplifier 156 receives a reference voltage from a secondary DC supply 159. The secondary DC supply 159 is referenced to ground 108. An output 160 of operational amplifier 156 connects to inverting input 154 through a capacitor C4 connected in parallel with a series combination of a resistor R4 and a capacitor C5. Output 160 also connects to a first end of a resistor R5. The other end of resistor R5 connects to an anode of opto-isolator 152. A cathode of opto-isolator 152 connects to ground 108. The feedback signal 140 is generated by an open-collector output of opto-isolator 152. An emitter of the open collector transistor connects to ground 108.

Referring now to FIG. 2 a second type of prior art two-stage converter 200 is shown. Two-stage converter 200 is identical to two-stage converter 100 with the exception of having a first stage 202 that includes a buck-converter of an alternate construction. First stage 202 receives power from DC supply 106. The positive terminal of DC supply 106 connects to a cathode of a rectifier D4 and to one end of a capacitor C10. The other end of capacitor C10 connects to one end of an inductor L3. The other end of inductor L3 connects to an anode of rectifier D4 and a drain of a FET Q10. A source of FET Q10 connects to one end of load sensing resistor R_{S}. A second end of load sensing resistor Rₛ connects to ground 108 and the negative terminal of DC supply 106. An output voltage of first stage 202 is generated across capacitor C10 and applied to the full bridge rectifier of second stage 104.

A buck control circuit 204 receives a sensed inductor current signal 206 that is generated across load sensing resistor R_{S}. Buck control circuit 204 uses a peak current mode control scheme that is implemented with a first integrated circuit U1. In some embodiments, U1 includes a UC3842 device available from Fairchild Semiconductor. Buck control circuit 204 generates a gate drive signal 208 that is applied to a gate of FET Q10 through a resistor R12. The other end of resistor R12 connects to pin 6 of integrated circuit U1. A secondary reference voltage 210 is referenced to ground 108 and connects to pin 7 of integrated circuit U1. The feedback signal 104 from opto-isolator 152 connects to one end of a resistor R14 and to pin 1 of integrated circuit U1. The other end of resistor R14 connects to pin 8 of integrated circuit U1 and to one end of a resistor R16. The other end of resistor R16 connects to one end of a resistor R17, one end of a capacitor C11, and pin 4 of integrated circuit U1. The other end of capacitor C11 connects to ground 108. A capacitor C12 connects between pin 3 of integrated circuit U1 and ground 108. pins 2 and 5 of integrated circuit U1 connect to ground 108. The sensed inductor current signal 206 connects to one end of a resistor R18. The other end of resistor R18 connects to the other end of resistor R17, the other end of capacitor C12, and pin 3 of integrated circuit U1. Integrated circuit U1 generates a ramp waveform at pin 4. The ramp waveform is added to the sensed inductor current signal 206 through resistor R17 and generates the gate drive signal fro FET Q10 at pin 6 of integrated circuit U1.

Referring now to FIG. 3 an output voltage waveform 220 is shown of the two-stage converter 200. The output voltage waveform shows a 712 mV peak-to-peak voltage ripple as a load applied to the two-stage converter 200 alternates between 4 A and 43 A at 0.3 A/uS. It is desirable to reduce the magnitude of the output ripple without introducing a complex and/or expensive control system.

### SUMMARY

A two-stage converter is disclosed that includes a buck converter, a DC-DC converter that receives power from the buck converter and generates an output voltage of the two-stage converter, and a buck control circuit that generates a control signal for the buck converter. The control signal is based on a first signal representing the output voltage, a second signal representing load applied to the buck converter, and a compensation signal. A characteristic of the compensation signal varies based on the output voltage.

A method of operating a two-stage converter is provided. The method includes reducing a first voltage to a second voltage, reducing the second voltage to a load voltage, and controlling the second voltage of based on a first signal representing the load voltage, a second signal representing load applied to the second voltage, and a compensation signal. A characteristic of the compensation signal varies based on the output voltage.

A two-stage converter is disclosed and includes a buck converter that reduces a first voltage to a second voltage, a DC-DC converter that reduces the second voltage to a load voltage, and a buck control circuit that generates a pulse-width modulated (PWM) control signal for the buck converter. A duty cycle of the control signal is based on the load voltage, a load applied to the buck converter, and a compensation signal based on the duty cycle.

A method of operating a two-stage converter is disclosed. The method includes reducing a first voltage to a second voltage, reducing the second voltage to a load voltage, and generating a pulse-width modulated (PWM) control signal that controls a difference between the first voltage and the second voltage. A duty cycle of the control signal is based on the load voltage, a load applied to the buck converter, and a compensation signal based on the duty cycle.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram of a first two-stage converter of the prior art;

FIG. 2 is a schematic diagram of a second two-stage converter of the prior art.

FIG. 3 is an output voltage waveform of the second two-stage converter of FIG. 2;

FIG. 4 is a schematic diagram of an improved two-stage converter;

FIG. 5 is a schematic diagram of a second improved two-stage converter;

FIG. 6 is a block diagram of a control scheme for a two-stage converter;

FIG. 7 is a schematic diagram of a dynamic ramp generator;

FIG. 8 is an output voltage waveform of the second improved two-stage converter.

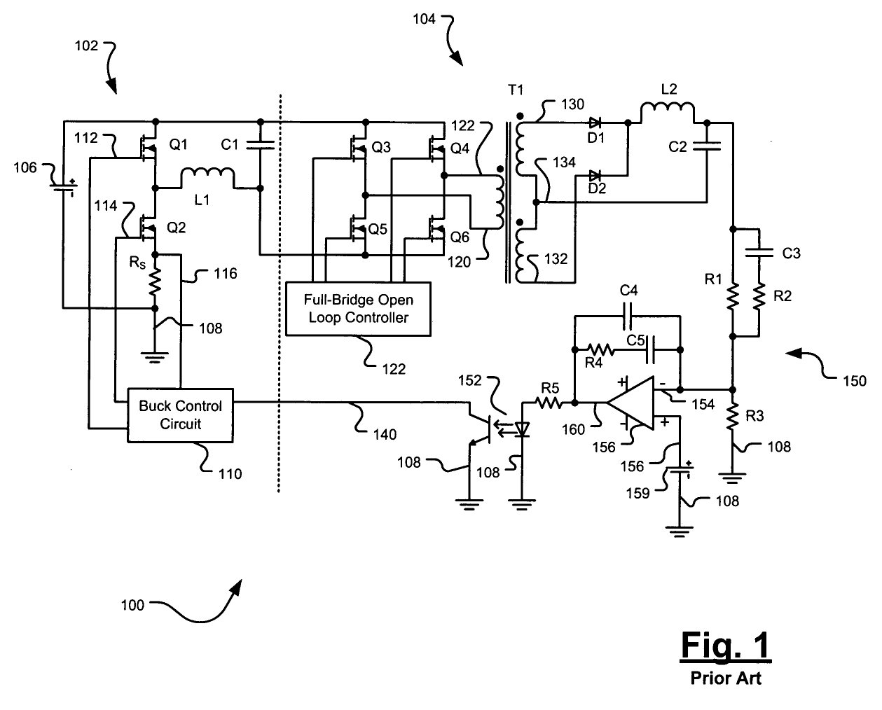

### DETAILED DESCRIPTION

The following description is merely exemplary in nature and is not intended to limit the present disclosure, application, or uses. It should be understood that throughout the drawings, corresponding reference numerals indicate like or corresponding parts and features.

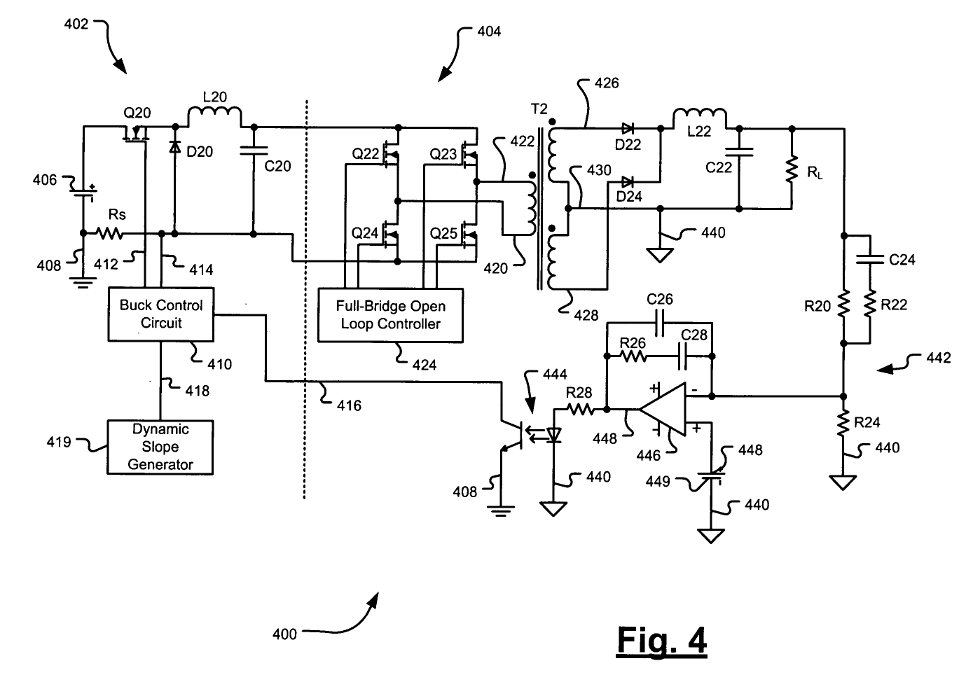

Referring now to FIG. 4, one of several embodiments of an improved two-stage converter 400 is shown. A first stage 402 includes a buck converter and a second stage 404 includes a full bridge DC-DC converter. First stage 402 receives power from a DC supply 406. A positive terminal of DC supply 406 connects to a drain of a FET Q20. A source of FET Q20 connects to a cathode of a rectifier D20 and one end of an inductor L20. The other end of inductor L20 connects to one end of a capacitor C20. The other end of capacitor C20 connects to an anode of rectifier D20. A negative terminal of DC supply 406 connects to ground 408 and to one end of a load sensing resistor R_{S}. The output voltage of first stage 402 is generated across capacitor C20.

A buck control circuit 410 generates a buck converter control signal 412 that is applied to first stage 402. In some embodiments, buck converter control signal 412 communicates with a gate of FET Q20. Buck control circuit 410 receives a load signal 414 that is generated across load sensing resistor R_{S}, a feedback signal 416 that is based on an output voltage signal of the two-stage converter 400, and a ramp signal 418. A characteristic, such as rise time of ramp signal 418, is based on the current draw of a load R_{L} that is applied to two-stage converter 400. Ramp signal 418 is generated by a dynamic slope generator 419. One of several embodiments of dynamic slope generator 419 is described below.

Second stage 404 receives power from first stage 402. The positive voltage at the first end of capacitor C20 is applied to drains of FETs Q22 and Q23. A source of FET Q22 connects to a drain of a FET Q24 and to a primary terminal 420 of a transformer T2. A source of FET Q23 connects to a drain of a FET Q25 and to a second terminal 422 of the primary winding of transformer T2. Sources of FETs Q24 and Q25 connect to the other end of capacitor C20. A full bridge open loop controller 424 generates gate signals that are applied to respective gates of FETs 022, Q23, Q24, and Q25.

Transformer T2 includes a center-tapped secondary winding that has a first terminal 426, a second terminal 428, and a center tap 430. First terminal 426 connects to an anode of a rectifier D22. Second terminal 428 connects to an anode of a rectifier D24. Cathodes of rectifiers D22 and D24 are connected together and to one end of an inductor L22. The other end of inductor L22 connects to one end of a capacitor C22. The other end of capacitor C22 connects to center tap 430 and a reference node 440. An output voltage of second stage 404 is generated across capacitor C22 and applied to a feedback compensation circuit 442.

Feedback compensation circuit 442 generates the feedback signal 416 based on the output voltage appearing across capacitor C22. Feedback compensation circuit 442 includes a first resistor R20 that is connected in parallel with a series combination of a resistor R22 and a capacitor C24. One end of resistor R20 receives the output voltage from capacitor C22. The other ends of resistors R20 and R22 connect to an inverting input of an operational amplifier 446 and to one end of a resistor R24. The other end of resistor R24 connects to reference node 440. A secondary power supply 449 is referenced to the reference node 440 and applies a positive voltage to a non-inverting input of operational amplifier 446. A feedback circuit connects between an output 448 and the inverting input of operational amplifier 446. The feedback circuit includes a capacitor C26 connected in parallel with a series combination of a resistor R26 and a capacitor C28. The output 448 connects to an input of an opto-isolator 444 through a resistor R28. An output of opto-isolator 444 generates the feedback signal 416.

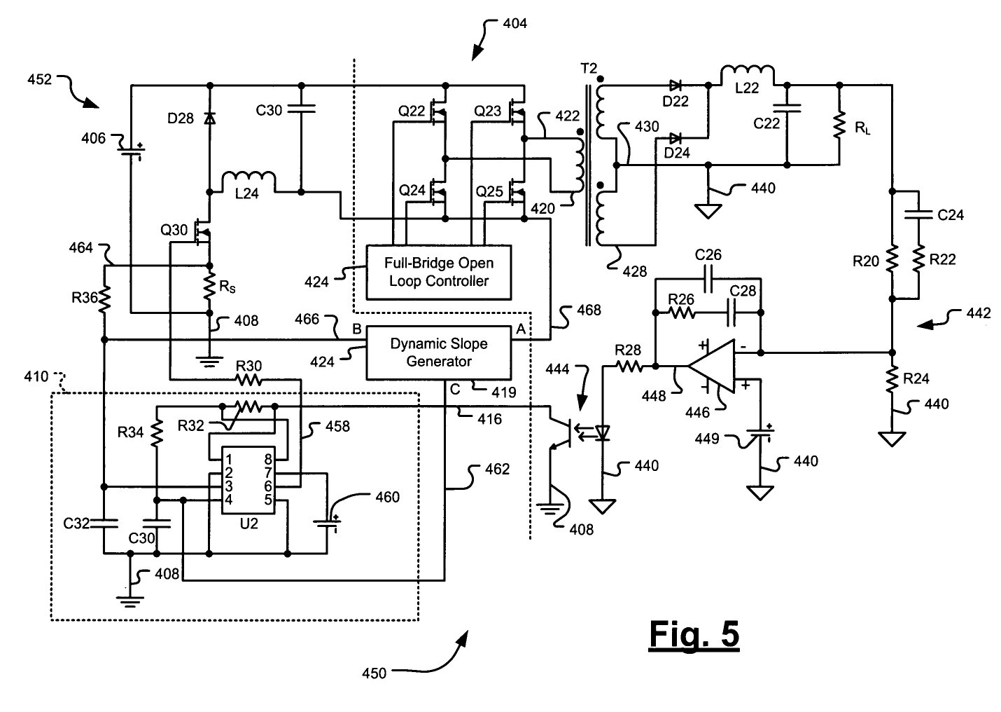

Referring now to FIG. 5 a second type of improved two-stage converter 450 is shown. Two-stage converter 450 is identical to two-stage converter 400 with the exception of having a first stage 452 of an alternate construction. First stage 452 includes a buck converter that receives power from DC supply 406. The positive terminal of DC supply 406 connects to a cathode of a rectifier D28 and to one end of a capacitor C30. The other end of capacitor C30 connects to one end of an inductor L24. The other end of inductor L24 connects to an anode of rectifier D28 and a drain of a FET Q30. A source of FET Q30 connects to one end of load sensing resistor R_{S}. A second end of load sensing resistor R_{S} connects to ground 408 and the negative terminal of DC supply 406. An output voltage of first stage 452 is generated across capacitor C30 and applied to the full bridge rectifier of second stage 404.

Some embodiments of buck control circuit 410 receive a sensed inductor current signal 206 that is generated across load sensing resistor R_{S}. Buck control circuit 410 uses a peak current mode control scheme that is implemented with an integrated circuit U2. In some embodiments, U2 includes a UC3842 device available from Fairchild Semiconductor. Buck control circuit 410 generates a gate drive signal 458 that is applied to a gate of FET Q30 through a resistor R30. The other end of resistor R30 connects to pin 6 of integrated circuit U2. A secondary reference voltage 460 is referenced to ground 408 and connects to pin 7 of integrated circuit U2. The feedback signal 416 from opto-isolator 444 connects to one end of a resistor R32 and to pin 1 of integrated circuit U2. The other end of resistor R32 connects to pin 8 of integrated circuit U2 and to one end of a resistor R34. The other end of resistor R34 connects to one end of a capacitor C30, pin 4 of integrated circuit U2, and to a first node 462 of one of several embodiments of dynamic slope generator 419. The other end of capacitor C30 connects to ground 408. A capacitor C32 connects between pin 3 of integrated circuit U2 and ground 408. Pins 2 and 5 of integrated circuit U2 connect to ground 408. The sensed inductor current signal 464 connects to one end of a resistor R36. The other end of resistor R36 connects to the other end of capacitor C32, pin 3 of integrated circuit U2, and a second node 466 of dynamic slope generator 419. A third node 468 of dynamic slope generator 419 connects to the junction between inductor L24 and capacitor C30.

Operation of buck control circuit 410 and dynamic slope generator 419 will now be described. Dynamic slope generator 419 generates a compensation ramp signal at node 466. Dynamic slope generator varies a rising slope of the compensation ramp signal according to the output current flowing through the load R_{L}. An amplitude of the compensation ramp signal increases in proportion to the output current as the duty cycle of gate control signal 458 increases with the output current. In other embodiments, other signals indicative of the current through the load R_{L} and the duty cycle of gate control signal 458 can be used to vary the compensation ramp.

The output voltage of the first stages 402 (FIG. 4) and 452 (FIG. 5) varies with the output current through R_{L}. The output voltage variations are due to voltage drops across the components in first stages 402 and 452 and due to compensating the duty cycle of the gate control 412 (FIG. 4) and 458 (FIG. 5) due to leakage inductance in transformer T2. The compensation ramp at second node 466 is continually adjusted such that the amplitude of the ramp decreases with as the voltage difference increases between DC supply 406 and the voltage across capacitor C30. This arrangement increases the amplitude of the compensation ramp in proportion to the output voltage of the first stages 402 and 452.

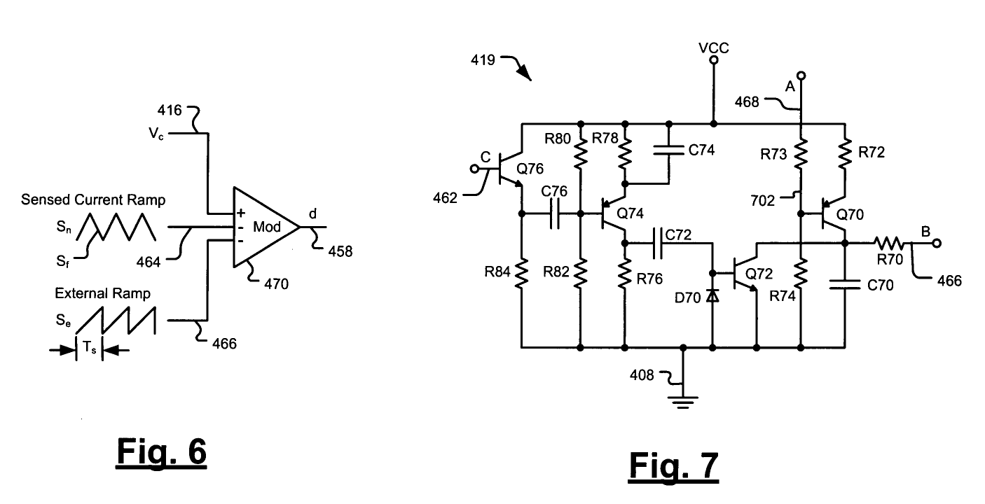

Referring to FIG. 6, a block diagram is shown of one of several embodiments of a control scheme employed by buck control circuit 410. A current-mode control modulator 470 generates the gate drive signal 458, which has a pulse width modulated (PWM) duty cycle d. A ramp of the sensed current signal is summed with the compensation ramp from dynamic slope generator 419 and compared with a reference voltage to control the duty cycle. In the embodiment of FIG. 5, the sensed current signal is provided by a sensed inductor current signal 464 and is summed with the compensation ramp at second node 466. These summed signals are compared with the reference voltage, which is provided by feedback signal 416, to control the duty cycle of gate drive signal 458.

Referring now to FIG. 7 one of several embodiments of dynamic slope generator 419 is shown. The dynamic slope signal is generated across a capacitor C70 and provided through a resistor R70 to second node 466. A first end of capacitor C70 connects to a collector of a PNP transistor Q70. An emitter of PNP transistor Q70 connects to one end of a resistor R72 and a secondary power supply VCC that is referenced to ground 408. A base-emitter junction of PNP transistor Q70 is biased by a resistor divider formed from series-connected resistors R73 and R74. The signal at third node 468 is applied to one end of the voltage divider formed by resistors R73 and R74. The base of transistor Q70 connects to a center tap 702 at the connection of resistors R73 and R74. The other end of the voltage divider formed by resistors R73 and R74 connects to ground 408.

A collector of an NPN transistor Q72 connects to capacitor C70 and the collector of transistor Q70. Transistor Q72 terminates the dynamic slope signal at second node 466 by discharging capacitor C70. An emitter of transistor Q72 connects to ground 408. A base of transistor Q72 connects to a cathode of a rectifier D70 and one end of a capacitor C72. The other end of capacitor C72 connects to one end of a resistor R76 and a collector of a PNP transistor Q74. An emitter of transistor Q74 connects to one end of a resistor R78 and one end of a capacitor C74. The other end of resistor R76 and an anode of diode D70 connect to ground 408. The other ends of resistor R78 and capacitor C74 connect together, to the other end of resistor R72, to one end of a resistor R80, and to a collector of an NPN transistor Q76. The other end of resistor R80 connects to a base of transistor Q74, to one end of a capacitor C76, and to one end of a resistor R82. The other end of capacitor C76 connects to an emitter of transistor Q76 and one end of a resistor R84. The other ends of resistors R82 and R84 connect to ground 408. A base of transistor Q76 connects to first node 462 of dynamic slope generator 419.

Operation of dynamic slope generator 419 will now be described. Resistors R72, R73, R74, transistor Q70, and capacitor C70 generate the ramp signal that appears at second node 466. The amplitude of the ramp signal is inversely proportional to the voltage at third node 468 with respect to ground 408. The remaining components of the dynamic slope generator 419 generate reset pulses so that the ramp signal is synchronized with a control oscillator ramp signal that is generated at pin 4 of integrated circuit U2 (FIG. 5). The ramp signal is added to the sensed inductor current signal 464 through resistor R70.

The voltage at third node 468 varies depending on the output load current of the two-stage converters 400 and 450. Due to the resistances of the power components in the two-stage converters 400 and 450, and the duty cycle loss because of the leakage inductance of transformer T2 (which is used for achieving ZVS for the primary switches), the output voltage of the first stages 402 and 452 needs to be increased with the increase in the output load current of the two-stage converters 400 and 450. The duty cycle of the gate drive signal 458 is therefore correspondingly increased. The output voltage of the first stages 402 and 452 increases as the duty cycle increases. As the amplitude of the ramp signal at second node 466 is increased with the increase in the output voltage of the first stages 402 and 452, the slope compensation is dynamically adjusted in proportion to the duty cycle and load current. Sensed current inductor signal 464 provides feedback regarding the load current being delivered by two-stage converters 400 and 450.

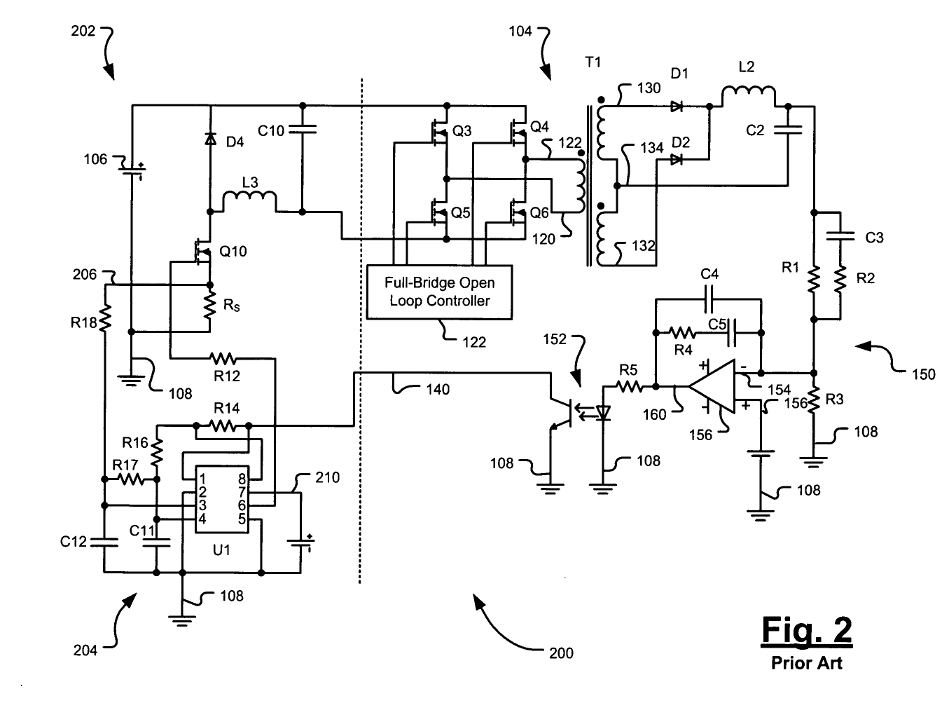

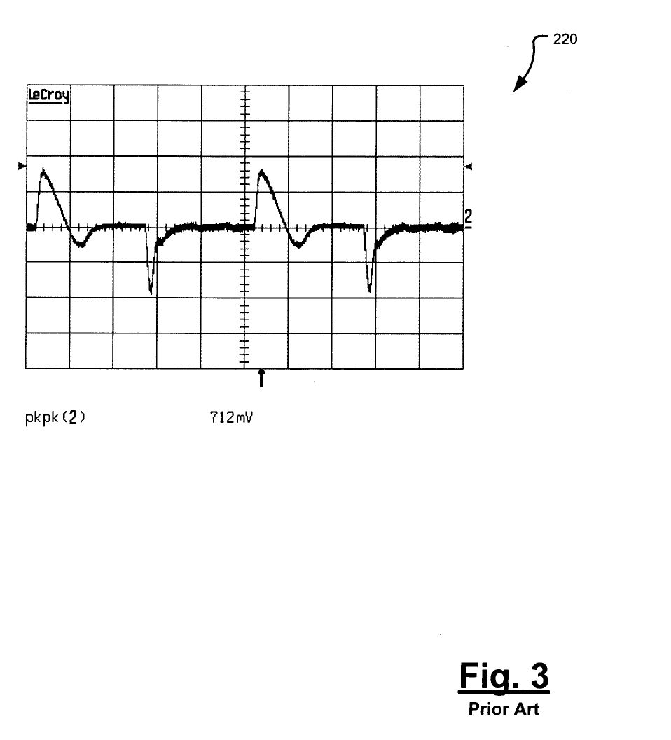

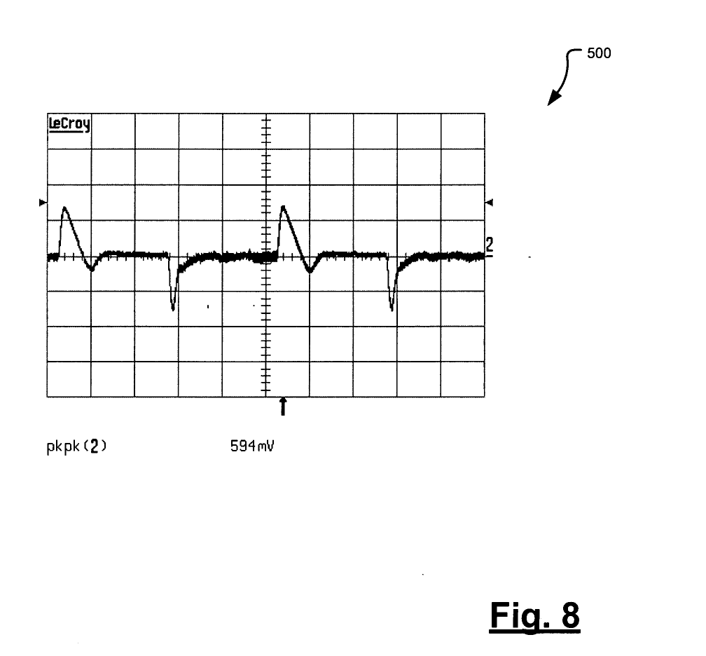

Referring now to FIG. 8 an output voltage waveform 500 is shown of two-stage converter 450. The output voltage waveform shows a 594 mV peak-to-peak voltage ripple as a load applied to the two-stage converter 450 alternates between 4 A and 43 A at 0.3 A/uS. This is an 188 mVp-p, or 16.6%, improvement in voltage ripple over the prior art design of FIG. 2 under the same operating conditions.

The description herein is merely exemplary in nature and, thus, variations that do not depart from the gist of that which is described are intended to be within the scope of the disclosure. Such variations are not to be regarded as a departure from the spirit and scope of the disclosure.

What is claimed is:

1. A two-stage converter comprising:
a buck converter;
a DC-DC converter that receives power from the buck converter and generates an output voltage of the two-stage converter; and
a buck control circuit that generates a control signal for the buck converter, wherein the control signal is based on a first signal representing the output voltage, a second signal representing load applied to the buck converter, and a compensation signal, and wherein a characteristic of the compensation signal varies based on the output voltage.

2. The two-stage converter of claim 1 wherein the characteristic includes a slope.

3. The two-stage converter of claim 1 further comprising a circuit that generates the compensation signal based on a load applied to the buck converter.

4. The two-stage converter of claim 1 further comprising a circuit that generates the compensation signal based on the load applied to the two-stage converter.

5. The two-stage converter of claim 4 wherein the circuit includes a resistor in series with the load and wherein the characteristic varies based on a load signal that is generated across the resistor.

6. The two-stage converter of claim 5 wherein the circuit includes a capacitor that is charged at a rate based on the load signal.

7. The two stage converter of claim 1 wherein the buck converter includes a buck regulator.

8. A method of operating a two-stage converter comprising:
reducing a first voltage to a second voltage;
reducing the second voltage to a load voltage; and
controlling the second voltage of based on a first signal representing the load voltage, a second signal representing load applied to the second voltage, and a compensation signal wherein a characteristic of the compensation signal varies based on the output voltage.

9. The method of claim 8 wherein the characteristic includes a slope.

10. The method of claim 8 further comprising generating the compensation signal based on a load applied to the second voltage.

11. The method of claim 8 further comprising generating the compensation signal based on the load voltage.

12. The method of claim 11 further comprising generating a signal based on a current flow through a load applied to the output voltage and varying the characteristic based on the signal.

13. A two-stage converter comprising:
buck converter means for reducing an input voltage to a second voltage;
DC-DC converter means for receiving power from the buck converter means and generating an output voltage of the two-stage converter; and
buck control means for generating a control signal for the buck converter means, wherein the control signal is based on a first signal representing the output voltage, a second signal representing load applied to the buck converter means, and a compensation signal, and wherein a characteristic of the compensation signal varies based on the output voltage.

14. The two-stage converter of claim 13 wherein the characteristic includes a slope.

15. The two-stage converter of claim 13 further comprising circuit means for generating the compensation signal based on a load applied to the buck converter means.

16. The two-stage converter of claim 13 further comprising circuit means for generating the compensation signal based on the load applied to the two-stage converter.

17. The two-stage converter of claim 16 wherein the circuit means includes current measuring means in series with the load and wherein the characteristic varies based on a current signal that is generated by the current measuring means.

18. The two-stage converter of claim 17 wherein the circuit means includes capacitive means for charging at a rate based on the load signal.

19. The two stage converter of claim 13 wherein the buck converter means includes buck regulator means for switching the input voltage in accordance with the control signal to generate the second voltage.

20. A two-stage converter comprising:
a buck converter that reduces a first voltage to a second voltage;
a DC-DC converter that reduces the second voltage to a load voltage; and
a buck control circuit that generates a pulse-width modulated (PWM) control signal for the buck converter, wherein a duty cycle of the control signal is based on the load voltage, a load applied to the buck converter, and a compensation signal based on the duty cycle.

21. The two-stage converter of claim 1 wherein the compensation signal includes a slope that varies based on the duty cycle.

22. The two-stage converter of claim 1 wherein the compensation signal is based on a difference between the second voltage and the first voltage.

23. The two-stage converter of claim 1 wherein the compensation signal is based on the second voltage.

24. The two-stage converter of claim 1 including a compensation circuit that generates the compensation signal based on a first signal indicative of the duty cycle and second signal indicative of the load voltage.

25. The two-stage converter of claim 24 wherein the compensation circuit includes a capacitor that charges and discharges based on the first signal and the second signal and wherein the compensation signal is developed by the capacitor.

26. A method of operating a two-stage converter, comprising:
reducing a first voltage to a second voltage;
reducing the second voltage to a load voltage; and
generating a pulse-width modulated (PWM) control signal that controls a difference between the first voltage and the second voltage, wherein a duty cycle of the control signal is based on the load voltage, a load applied to the buck converter, and a compensation signal based on the duty cycle.

27. The method of claim 26 wherein the compensation signal includes a slope that varies based on the duty cycle.

28. The method of claim 26 wherein the compensation signal is based on a difference between the second voltage and the first voltage.

29. The method of claim 26 wherein the compensation signal is based on the second voltage.

30. The method of claim 26 further including generating the compensation signal based on a first signal indicative of the duty cycle and second signal indicative of the load voltage.

31. The method of claim 30 wherein the generating step includes charging and discharging an energy storage device based on the first signal and the second signal.
